(19) United States
(12) Patent Application Publication
(10) Pub. No.: US 2009/0258103 A1
(43) Pub. Date: Oct. 15, 2009

(54) Multi-Head Extruder Assembly

(75) Inventors: Edward Williams, St. Louis, MO (US); Alan Eugene Kirkland, Crystal City, MO (US)

Correspondence Address: STORM LLP, BANK OF AMERICA PLAZA, 901 MAIN STREET, SUITE 7100, DALLAS, TX, 75202, US

(73) Assignee: GOOD EARTH TOOLS, INC., Crystal City, MO (US)

(21) Appl. No.: 12/100,964

(22) Filed: Apr. 10, 2008

(51) Int. Cl. B29C 47/08

(52) U.S. Cl. 425/461

(57) ABSTRACT

An extruder that is adapted to provide a flow of an extrudate is provided. There is a frame having a plurality of storage positions, a discharge position and a plurality of extruder heads. Each extruder head is secured to the frame and is movable between one of the storage positions and the discharge position. A sealing member is provided that is secured to the extruder. The sealing member is adapted to move between an engaged position and a disengaged position, wherein the sealing member moves from the disengaged position to the engaged position so as to engage one of the extruder heads when it is in the discharge position.

### CROSS-REFERENCE TO RELATED APPLICATION

This application is related to co-pending patent application Ser. No. ______ filed ______ and entitled “Thermal Growth Compensating Extrusion Screw Assembly,” which is hereby incorporated by reference for all purposes.

### TECHNICAL FIELD

The invention relates generally to an extruder assembly and, more particularly, to a multi-head extruder assembly.

### BACKGROUND

Today, extruders are used in many applications ranging from plastics to pet foods. One example, in particular, is the manufacture of pet foods where different shapes of dried pet food are produced in the same extruder. To produce each of these different shapes, different die plates (having the desired shape) are employed. However, making such different shapes is not so easy a task because it requires the changing of a head assembly. Some examples of conventional extruder designs are U.S. Patent Application Publication Number 2007/0237853 and U.S. Pat. Nos. 2,661,497; 3,130,468; 3,708,256; and 5,498,380. Therefore, there is a need for an extruder that allows for changing of extruder heads quickly.

### SUMMARY

The present invention, accordingly, provides an extruder assembly. An extruder that is adapted to provide a flow of an extrudate is provided. There is a frame having a plurality of storage positions, a discharge position and a plurality of extruder heads. Each extruder head is secured to the frame and is movable between one of the storage positions and the discharge position. A sealing member is provided that is secured to the extruder. The sealing member is adapted to move between an engaged position and a disengaged position, wherein the sealing member moves from the disengaged position to the engaged position so as to engage one of the extruder heads when it is in the discharge position.

In accordance with another preferred embodiment of the present invention, each extruder head further comprises a seat that is adapted to receive the sealing member.

In accordance with another preferred embodiment of the present invention, each seat further comprises a groove that is generally coextensive with at least a portion of the seat and a resilient gasket secured in the groove.

In accordance with another preferred embodiment of the present invention, the gasket is made of TEFLON.

In accordance with another preferred embodiment of the present invention, the sealing member further comprises a flange that is adapted to be received in each seat.

In accordance with another preferred embodiment of the present invention, each extruder head further comprises a shroud that is secured to the frame and a die plate disposed within the shroud.

In accordance with another preferred embodiment of the present invention, the sealing member further comprises a linearly translatable drive member that is secured to the extruder and a flange that is secured to the drive member that is adapted to engage one of the extruder heads.

In accordance with another preferred embodiment of the present invention, an assembly that is adapted to cooperate with an extruder is provided. A frame having a plurality of storage positions, a discharge position and a plurality of extruder heads is provided. Each extruder head is secured to the frame, is movable between one of the storage positions and the discharge position, and has a seat. Also provided is a sealing member having a flange that is secured to the extruder. The sealing member is adapted to move between an engaged position and a disengaged position, wherein the flange engages the seat of one of the extruder heads when it is in the discharge position.

In accordance with another preferred embodiment of the present invention, an extruder assembly is provided. A housing is provided that is in fluid communication with a supply of extrudate, wherein the housing has a longitudinal axis. An extruder screw is disposed in the housing. The screw is adapted to generate a flow of the extrudate. A sealing member is disposed on the exterior of the housing and secured to the housing. The sealing member has a linearly translatable drive member that is adapted to move in the direction of the longitudinal axis, a face seal disposed between the drive member and the housing, and a flange that is secured to the drive member. A frame is provided, having a plurality of storage positions and a discharge position, and a plurality of extruder heads is provided. Each extruder head is secured to the frame and is movable between one of the storage positions and the discharge position. Each extruder head comprises a seat that is adapted to receive the flange.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an isometric view of the extruder assembly in accordance with a preferred embodiment of the present invention;

FIG. 2 is another isometric view of the extruder assembly of FIG. 1;

FIG. 3 is a top view of the extruder assembly of FIG. 1;

FIG. 4 is a rear elevation of the extruder assembly of FIG. 1;

FIG. 5 is a side elevation of the extruder assembly of FIG. 1;

FIG. 6 is a cross-sectional view of the extruder assembly of FIG. 4 along section line A-A; and

FIG. 7 is an exploded cross-sectional view of FIG. 6 along section line B-B.

### DETAILED DESCRIPTION

Refer now to the drawings wherein depicted elements are, for the sake of clarity, not necessarily shown to scale and wherein like or similar elements are designated by the same reference numeral through the several views.

With extruders, as with all manufacturing, throughput is important, and when a die plate is changed or repair is undertaken, the throughput is affected. In particular, extruders usually operate at high temperatures and pressures (sometimes greater than 300° F. and greater than 1000 PSI) to force an extrudate, such as plastic or food products, through a die. Thus, changing a die plate or undertaking a repair can take the extruder off-line for several hours or days, which can significantly affect the productivity and profitability of the extruder.

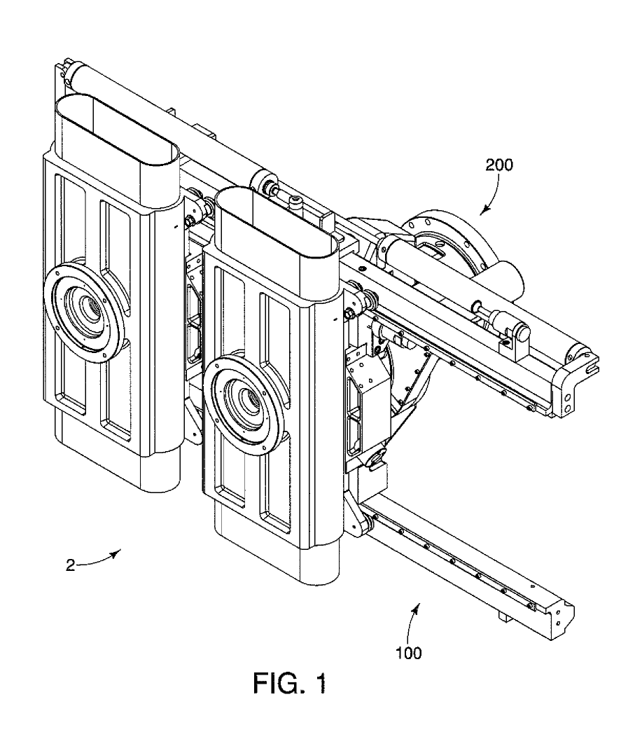

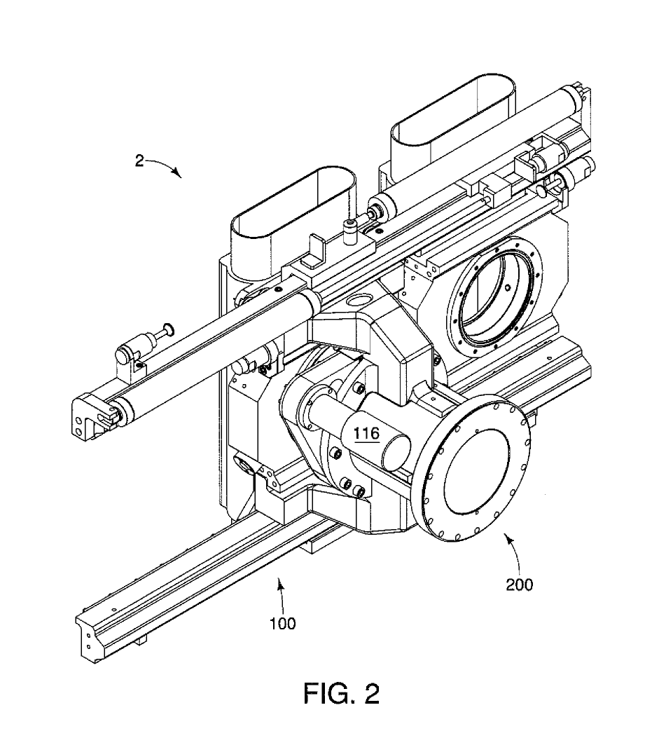

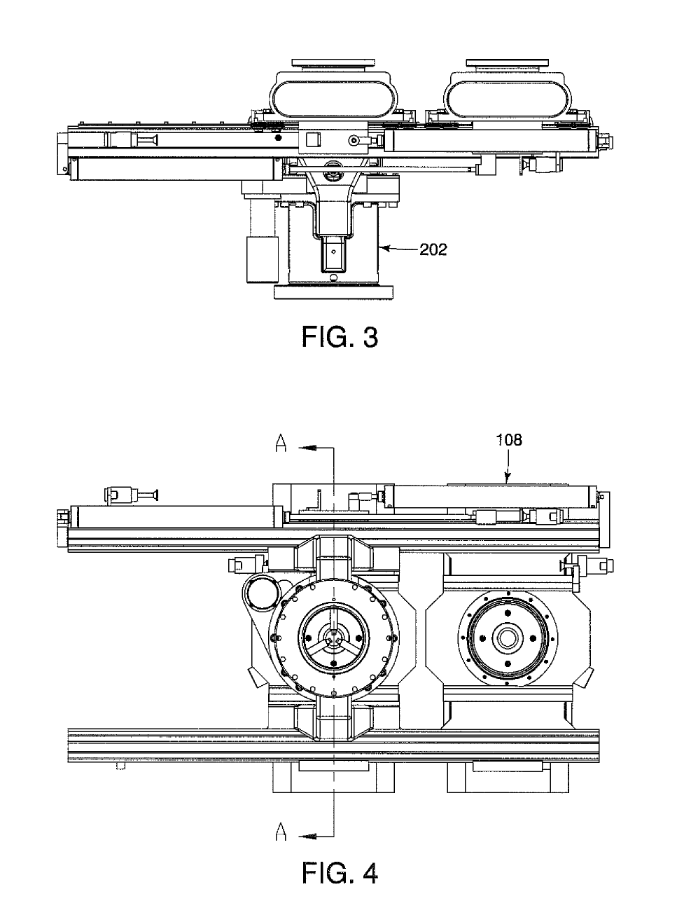

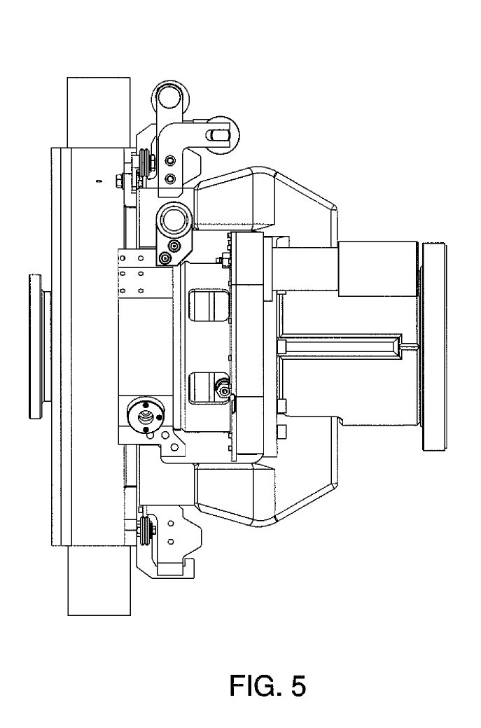

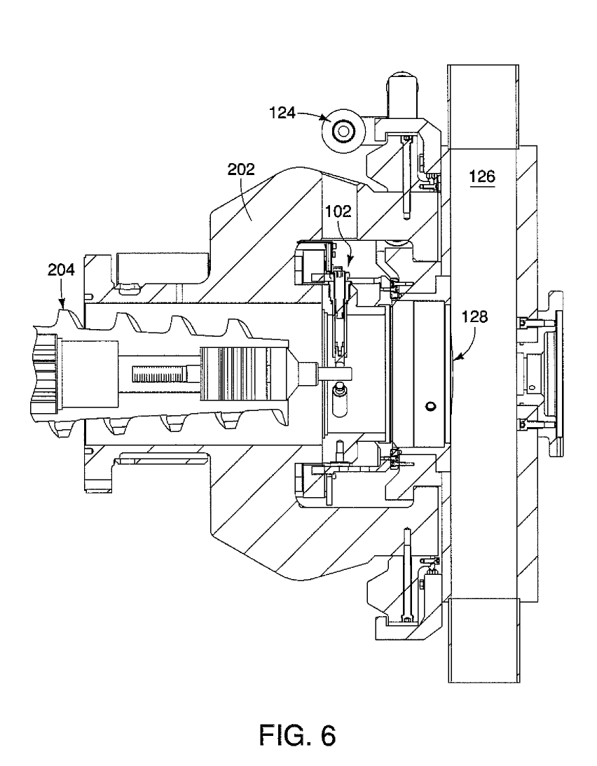

Referring to FIGS. 1-7 of the drawings, an extruder assembly 2 is shown having multiple heads. The assembly 2 is comprised of a multi-head assembly 100 and an extruder 200 that cooperate with one another. In particular, this assembly 2 would allow for rapid repair or replacement of die plates on the order of minutes or seconds as opposed to hours or days. Preferably, the extruder 200 has a generally cylindrical housing 202 with an extruder screw 204 disposed therein. The extruder screw 204 that is disposed within the housing 202 is adapted to rotate within the housing 202 (along the central axis of the housing 202) to impart mechanical work to an extrudate contained within the housing 202 to form a flow of extrudate in the direction of the assembly 100.

Secured to the extruder 200 is a sealing member 102. Preferably, the sealing member 102 is secured to the exterior of the housing 202 and is adapted to be linearly translatable or telescope while being secured to the housing 202. While being linearly translatable, the sealing member 102 does have at least two positions: a discharge position and an engaged position. In the discharge position, the sealing member 102 is translated to a position away from the extruder heads 108, leaving a gap between the housing 202 and the extruder heads 108. In the engaged position, the sealing member 102 is translated to a position such that the sealing member 104 engages at least one of the extruder heads 108, providing a generally continuous fluid seal between the housing 202 and one of the extruder heads 108.

The sealing member 102 can further be divided into several portions, namely a driving member 104 and a flange 106. The driving member 104 is the portion of sealing member 102 that is generally responsible for providing a generally continuous fluid seal between the housing 202 and the environment and is generally responsible for providing linear motion, while the flange 106 is generally adapted to engage one of the extruder heads 108 so as to provide a generally continuous fluid seal between one of the extruder heads 108 and the housing 202. Preferably, disposed between the housing 202 and the driving member 104 is a face seal 110 that is secured in a radial groove 112. The face seal 110 can generally be made of a resilient material, preferably TEFLON. The face seal 110 would provide a barrier between the extrudate and the environment so that internal pressure and temperature can be generally maintained. Included with the driving member 104 is an actuator assembly 114 (preferably an electric motor 116 and transmission 118 that employs gears and ACME threads) to move the driving member 104 between the engaged position and disengaged position. Typically, movement from the engaged position to the disengaged position (and vice versa) takes about 5 to 8 seconds. Alternatively, an air gear-motor or pneumatic cylinder assembly can operate as the actuator assembly 114.

Secured to the end opposite the actuator assembly 114 on the driving member 104 is the flange 106. The flange 106 includes a lip 122 that contacts the at least one of the extruder heads 108. The lip 122 is generally circular and has a generally semicircular or generally curvilinear cross-section with a radius of about ¼-inch.

Adjacent to the extruder 200 is the frame 120. The frame 120 provides mechanical support for the heads 108. As can be seen in FIGS. 1-7, the heads 108 are able to move linearly on the frame 120. In particular, the frame 120, as depicted, has a discharge position located in proximity to the extruder 200 and several storage positions, preferably one storage position for each head 108. When an extruder head 108 is located at the storage position, the sealing member 102 can engage extruder head 108 and an extrudate can be fed through or extruded through the head 108. Additionally, when an extruder head 108 is located at a storage position, the head 108 is not in fluid communication with the extrudate.

Thus, during operation, the sealing member 102 can be moved from an engaged position with one of the extruder heads 108 to the disengaged position, and the extruder head 108 is moved to its storage position. Thereafter, another extruder head 108 can be moved from its storage position to the discharge position, and the sealing member 102 can be moved from the disengaged position to an engaged position with the extruder head 108. To accomplish movement between the storage positions and the discharge position, actuators 124, which are secured to the frame 120 and at least one of the extruder heads 108, are employed. These actuators 124 cause the heads 108 to move linearly on the frame. Preferably, the actuators 124 are comprised on pneumatic cylinders. Typically, it takes about 2 to 3 seconds to move one extruder head 108 from the discharge position to its storage position and move another head 108 from its storage position to the discharge position.

As can be seen in FIGS. 1-7, the extruder heads 108 are further comprised of several components. On the exterior of the heads 108 is a shroud 126, which has a die plate 128 disposed therein. The shroud 126 has a generally hollow interior, and typically includes a knife assembly (not shown) disposed therein that abuts the die plate 128. One reason for having this generally hollow shroud 126 is to insulate the cutting assembly (not shown) from the environment to prevent items from interfering with the cutting assembly (not shown). Additionally, the shroud 126 allows for directional control of the extruded product (dropped through the bottom by gravity or through the top by vacuum system).

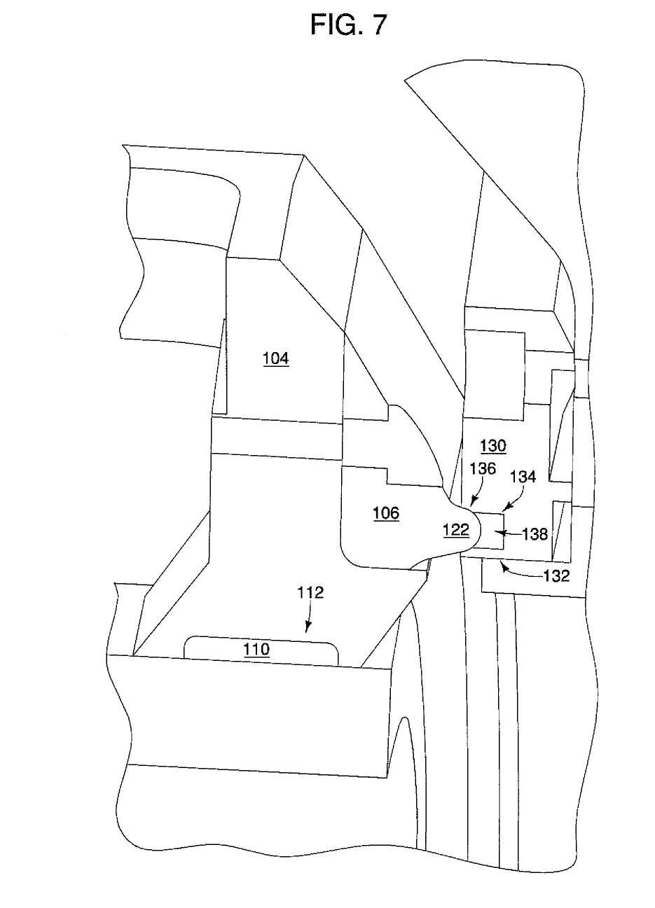

A seating assembly 130 is secured to the shroud 126. The seating assembly 130 is the portion of the head 108 that is in fluid communication with the extruder 200, when engaged. Typically, that the die plate 128 is secured to the seating assembly 130 as a “free-floating” assembly, where the die plate 128 is secured into its position with a single push rod actuated by an air cylinder (not shown) to prevent rotation of the die assembly during extrusion. Thus, this arrangement would allow the knife assembly (not shown) to be held in an interference relationship with the die plate 128 during actuation of the heads 108 and would allow for easy removal of die plate 128 when the head 108 is in its storage position. Opposite the die plate 128, the seating assembly 130 includes a generally circular seat 132, having a diameter that is approximately equal to the diameter of the lip 122. Formed in the seat 132 is a groove 134, which is generally coextensive with at least a portion of the seat 132. On either side of the groove 134 are mating portions 136 that have a generally curvilinear cross section and are generally adapted to have a shape that can engage at least a portion of the lip 122. As can be seen in FIG. 7, the groove 134 has a generally rectangular cross section, and a seal 138 is secured in the groove 134. This seal 138 is formed of a resilient material, such as TEFLON, that is adapted to engage at least a portion of the lip 122. When under pressure and engaging the lip 122, the seal 138 is deformed and compressed to form a generally continuous fluid seal between the extrudate and the environment.

Therefore, by having a sealing member 102 that can rapidly engage and disengage heads 108 and by having the heads 108 rapidly movable between positions, it is a relatively simple procedure to replace a die plate, such as die plate 128, or make a repair. Thus, the throughput of the extruder assembly 2 can be dramatically increased by reducing the downtime of the extruder assembly 2 between changes to the die plate 128 or to make other repairs.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. An extruder assembly, comprising:
an extruder that is adapted to provide a flow of an extrudate;
a frame having a plurality of storage positions and a discharge position;
a plurality of extruder heads, each extruder head being secured to the frame, and each extruder head being movable between one of the storage positions and the discharge position;
a sealing member that is secured to the extruder, the sealing member being adapted to move between an engaged position and a disengaged position, wherein the sealing member moves from the disengaged position to the engaged position so as to engage one of the extruder heads when it is in the discharge position.

2. The extruder assembly of claim 1, wherein each extruder head further comprises a seat that is adapted to receive the sealing member.

3. The extruder assembly of claim 2, wherein each seat further comprises:
a groove that is generally coextensive with at least a portion of the seat; and
a resilient gasket secured in the groove.

4. The extruder assembly of claim 3, wherein the gasket is made of TEFLON.

5. The extruder assembly of claim 2, wherein the sealing member further comprises a flange that is adapted to be received in each seat.

6. The extruder assembly of claim 1, wherein each extruder head further comprises:
a shroud that is secured to the frame; and
a die plate disposed within the shroud.

7. The extruder assembly of claim 1, wherein the sealing member further comprises:
a linearly translatable drive member that is secured to the extruder; and
a flange that is secured to the drive member that is adapted to engage one of the extruder heads.

8. An assembly that is adapted to cooperate with an extruder, comprising:
a frame having a plurality of storage positions and a discharge position;
a plurality of extruder heads, each extruder head being secured to the frame, and each extruder head being movable between one of the storage positions and the discharge position, and each extruder head having a seat; and
a sealing member having a flange that is secured to the extruder, the sealing member being adapted to move between an engaged position and a disengaged position, wherein the flange engages the seat of one of the extruder heads when it is in the discharge position.

9. The assembly of claim 8, wherein each seat further comprises:
a groove that is generally coextensive with at least a portion of the seat; and
a resilient gasket secured in the groove.

10. The assembly of claim 9, wherein the gasket is made of TEFLON.

11. The assembly of claim 8, wherein the sealing member further comprises a flange that is adapted to be received in the seat.

12. The assembly of claim 8, wherein each extruder head further comprises:
a shroud that is secured to the frame; and
a die plate disposed within the shroud.

13. An extruder assembly, comprising:
a housing that is in fluid communication with a supply of extrudate, the housing having a longitudinal axis;
an extruder screw disposed in the housing, the screw being adapted to generate a flow of the extrudate;
a sealing member disposed on the exterior of the housing and secured to the housing, the sealing member having:
a linearly translatable drive member that is adapted to move in the direction of the longitudinal axis;
a face seal disposed between the drive member and the housing; and
a flange that is secured to the drive member;
a frame having a plurality of storage positions and a discharge position; and
a plurality of extruder heads, each extruder head being secured to the frame, and each extruder head being movable between one of the storage positions and the discharge position, and each extruder head having a seat that is adapted to receive the flange.

14. The assembly of claim 13, wherein each seat further comprises:
a groove that is generally coextensive with at least a portion of the seat; and
a resilient gasket secured in the groove.

15. The assembly of claim 14, wherein the gasket is made of TEFLON.

16. The assembly of claim 13, wherein the sealing member further comprises a flange that is adapted to be received in the seat.

17. The assembly of claim 13, wherein each extruder head further comprises:
a shroud that is secured to the frame; and
a die plate disposed within the shroud.

18. The assembly of claim 13, wherein the face seal is made of TEFLON.
